(19) United States
(12) Patent Application Publication
(10) Pub. No.: US 2014/0098113 A1
(43) Pub. Date: Apr. 10, 2014

(54) NETWORK-ENABLED GRAPHICS PROCESSING UNIT

(71) Applicant: Advanced Micro Devices, Inc., Sunnyvale, CA (US)

(72) Inventor: Mazda Sabony, Unterhaching (DE)

(73) Assignee: Advanced Micro Devices, Inc., Sunnyvale, CA (US)

(21) Appl. No.: 13/648,802

(22) Filed: Oct. 10, 2012

(51) Int. Cl. G06F 13/14; G06F 15/80

(52) U.S. Cl. 345/505; 345/519

(57) ABSTRACT

The present invention provides an apparatus that includes a network-enabled graphics processing unit. In one embodiment, the apparatus includes integrated circuit that includes a graphics processing element, a media fragmentation engine, and a network interface controller for conveying packets to or from the integrated circuit. The media fragmentation engine translates between a packet format used by the network interface and a graphics format used by the graphics processing element.

### BACKGROUND

This application relates generally to processor-based systems, and, more particularly, to graphics processing units in processor based systems.

Conventional processor-based systems from personal computers to mainframes typically include a central processing unit (CPU) that is configured to access instructions or data that are stored in a main memory. Processor-based systems may also include other types of processors such as graphics processing units (GPUs), digital signal processors (DSPs), accelerated processing units (APUs), co-processors, or applications processors. Entities with the conventional processor-based system communicate by exchanging signals over buses or bridges such as a northbridge, a southbridge, a Peripheral Component Interconnect (PCI) Bus, a PCI-Express Bus, or an Accelerated Graphics Port (AGP) Bus.

### SUMMARY OF EMBODIMENTS

The disclosed subject matter is directed to addressing the effects of one or more of the problems set forth herein. The following presents a simplified summary of the disclosed subject matter in order to provide a basic understanding of some aspects of the disclosed subject matter. This summary is not an exhaustive overview nor is it intended to identify key or critical elements of the disclosed subject matter or to delineate the scope of the disclosed subject matter. Its sole purpose is to present some concepts in a simplified form as a prelude to the more detailed description that is discussed later.

In one embodiment, an apparatus is provided that includes a network-enabled graphics processing unit. One embodiment of the apparatus includes an integrated circuit that includes a graphics processing element, a media fragmentation engine, and a network interface controller for conveying packets to or from the integrated circuit. The media fragmentation engine translates between a packet format used by the network interface and a graphics format used by the graphics processing element.

In another embodiment, an apparatus is provided that includes a network-enabled graphics processing unit. One embodiment of the apparatus includes one or more network-enabled graphics processing units that include a graphics processing element, a media fragmentation engine, and a network interface controller for conveying packets to or from the integrated circuit. The media fragmentation engine translates between a packet format used by the network interface and a graphics format used by the graphics processing element. This embodiment also includes one or more connectors for communicatively coupling to the network interface controller.

In yet another embodiment, a computer readable media is provided that includes instructions that when executed can configure a manufacturing process used to manufacture a semiconductor device. One embodiment of the semiconductor device includes an integrated circuit including a graphics processing element, a media fragmentation engine, and a network interface controller for conveying packets to or from the integrated circuit. The media fragmentation engine translates between a packet format used by the network interface and a graphics format used by the graphics processing element.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a processor-based system;

FIG. 2 conceptually illustrates a first exemplary embodiment of a semiconductor device that may be formed in or on a semiconductor wafer;

FIG. 3 conceptually illustrates one exemplary embodiment of a packet;

FIG. 4 conceptually illustrates a second exemplary embodiment of a processor-based system;

FIG. 5 conceptually illustrates a third exemplary embodiment of a processor-based system;

FIG. 6 conceptually illustrates a fourth exemplary embodiment of a processor-based system;

FIG. 7 conceptually illustrates a fifth exemplary embodiment of a processor-based system;

FIG. 8 conceptually illustrates a sixth exemplary embodiment of a processor-based system;

FIG. 9 conceptually illustrates a seventh exemplary embodiment of a processor-based system; and

FIG. 10 conceptually illustrates an eighth exemplary embodiment of a processor-based system.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

Conventional graphics processing units (GPUs) communicate with other elements of a computing system over internal buses such as peripheral component interconnect (PCI) buses. For example, GPUs can exchange data and control signals with CPUs to coordinate operation of the two processing elements to perform operations such as rendering of graphics for output to a display unit. However, the bandwidth of a typical PCI bus may range from 250 MB/s to 2 GB/s in each direction per lane in the bus. This limits the bandwidth available to support the exchange of control or data signals between the GPU and other elements of the system. The limits on the bandwidth of the PCI bus also limit the number of GPUs that can be deployed in the system for parallel or concurrent operation. Furthermore, conventional GPUs are implemented as a part of the system and need to be connected to the system (e.g., via the PCI/PCIe bus) prior to booting up the system. Conventional GPUs cannot be “hot plugged” in to the system after boot and so it is not possible to connect additional GPUs when the system is running. Moreover, a connected GPU cannot be powered on and off when the system is running. Conventional GPUs can only be connected to a single host and consequently only one host can use the connected GPU.

At least in part to address these drawbacks in the conventional practice, the present application describes embodiments of a network-enabled graphics processing unit (NGPU). The NGPU may be implemented on a chip or on a board. In one embodiment, a network interface controller (NIC) may be integrated into the NGPU to allow control or data signals to be communicated over network connections to other entities. For example, an NGPU that includes an integrated NIC can use the network interface to communicate with one or more CPUs (or other processing units) over networks such as Ethernet connections to coordinate operation of the processing elements. Network connections that operate according to Ethernet standards can support bandwidths that are orders of magnitude higher than the bandwidth of a typical PCI bus. For example, Ethernet network controllers may support information exchange at speeds of 10 Gbit/s, 100 Gbit/s, 1000 Gbit/s, or even higher. Such controllers may be referred to as 10/100/1000 Ethernet controllers, which means that the controller can support a notional maximum transfer rate of 10, 100 or 1000 Gigabits per second. Using the network interface (perhaps in combination with a PCI interface to a PCI bus) allows the NGPU to exchange more information with other elements of the system and, in some embodiments, allows significantly larger numbers of NGPUs to be deployed for parallel or concurrent operation. Moreover, one or more NGPUs can be hot-plugged into a system following boot up of the system.

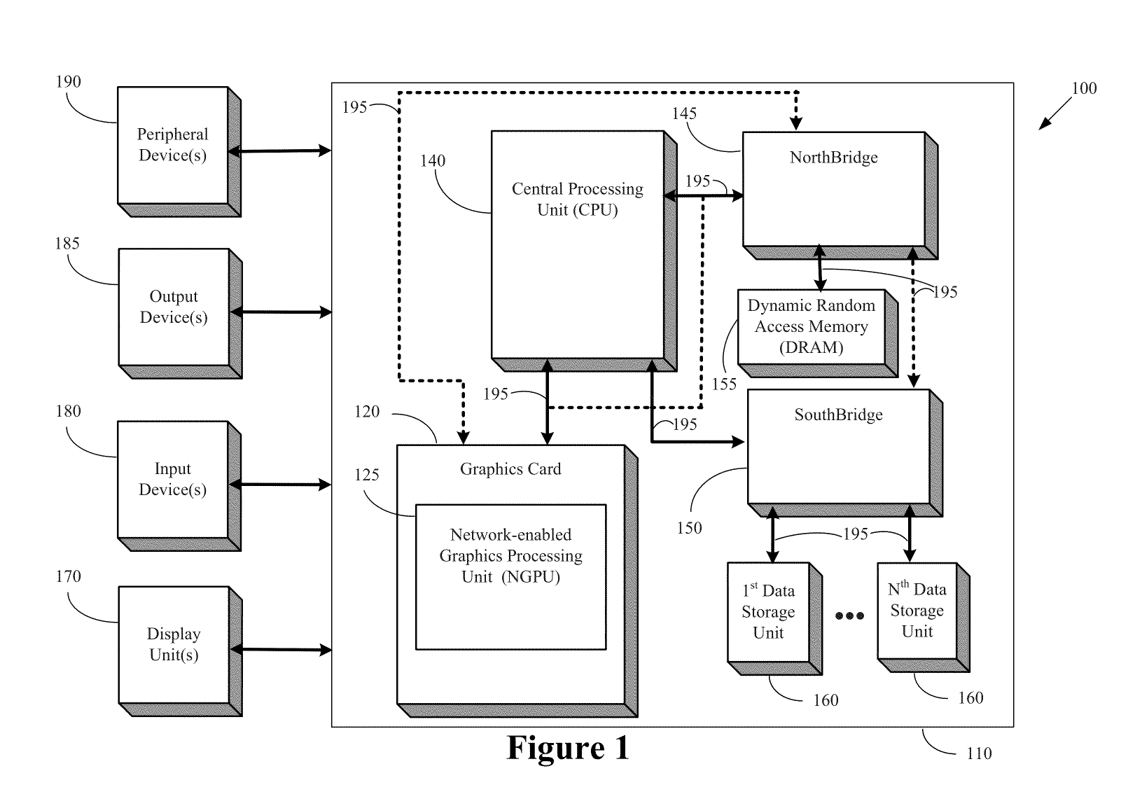

FIG. 1 conceptually illustrates a first exemplary embodiment of a processor-based system 100. In various embodiments, the processor-based system 100 may be a personal computer, a laptop computer, a handheld computer, a netbook computer, an ultrabook computer, a mobile device, a smart phone, a telephone, a personal data assistant, a server, a mainframe, a work terminal, or the like. The computer system includes a main structure 110 which may be a computer motherboard, system-on-a-chip, circuit board or printed circuit board, a desktop computer enclosure or tower, a laptop computer base, a server enclosure, part of a mobile device, personal data assistant, or the like. In one embodiment, the computer system 100 runs an operating system such as Linux, UNIX, Windows, Mac OS, or the like.

In the illustrated embodiment, the main structure 110 includes a graphics card 120. In one embodiment, the graphics card 120 may contain a network-enabled graphics processing unit (NGPU) 125 used in processing graphics data. As discussed herein, the NGPU 125 may include a network interface controller that allows the NGPU 125 to communicate with other entities (either internal or external to the system 100) over one or more networks, e.g., over a 10/100/1000 Ethernet connection. The graphics card 120 may also, in alternative embodiments that may be implemented in conjunction with the network interface described herein, be connected on a Peripheral Component Interconnect (PCI) Bus (not shown), PCI-Express Bus (not shown), an Accelerated Graphics Port (AGP) Bus (also not shown), or other electronic or communicative connection. In various embodiments the graphics card 120 may be referred to as a circuit board or a printed circuit board or a daughter card or the like. For example, semiconductor devices used to form the graphics card 120 or NGPU 125 may be formed on a single substrate. Although the illustrated embodiment shows the NGPU 125 being deployed on the graphics card 120, alternative embodiments may deploy the NGPU 125 on a chip, a board, a card, or other structure.

The computer system 100 shown in FIG. 1 also includes a central processing unit (CPU) 140, which is electronically or communicatively coupled to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other electronic or communicative connection, as discussed herein. For example, CPU 140, northbridge 145, GPU 125 may be included in a single package or as part of a single die or “chips”. In certain embodiments, the northbridge 145 may be coupled to a system RAM (or DRAM) 155 and in other embodiments the system RAM 155 may be coupled directly to the CPU 140. The system RAM 155 may be of any RAM type known in the art; the type of RAM 155 does not limit the embodiments of the present invention. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125, or DRAM 155 may be a computer chip or a silicon-based computer chip, or may be part of a computer chip or a silicon-based computer chip. The various components of the computer system 100 may be operatively, electrically or physically connected or linked with a connection 195 or more than one connection 195. In the illustrated embodiment, the connections 195 include network connections such as 10/100/1000 Ethernet connections. However, persons of ordinary skill in the art having benefit of the present disclosure should appreciate that alternative embodiments may use different connections 195. For example, the connections 195 may be network connections that operate according to different speeds (e.g., speeds lower than 10 Gbe or higher than 1000 Gbe) and in some cases the connections 195 may also include other buses such as PCI or PCIe buses.

The computer system 100 may be connected to one or more display units 170, input devices 180, output devices 185, or peripheral devices 190. In various alternative embodiments, these elements may be internal or external to the computer system 100 and may be wired or wirelessly connected. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier, or other output device. The peripheral devices 190 may be any other device that can be coupled to a computer. Exemplary peripheral devices 190 may include a CD/DVD drive capable of reading or writing to physical digital media, a USB device, Zip Drive, external floppy drive, external hard drive, phone or broadband modem, router/gateway, access point or the like.

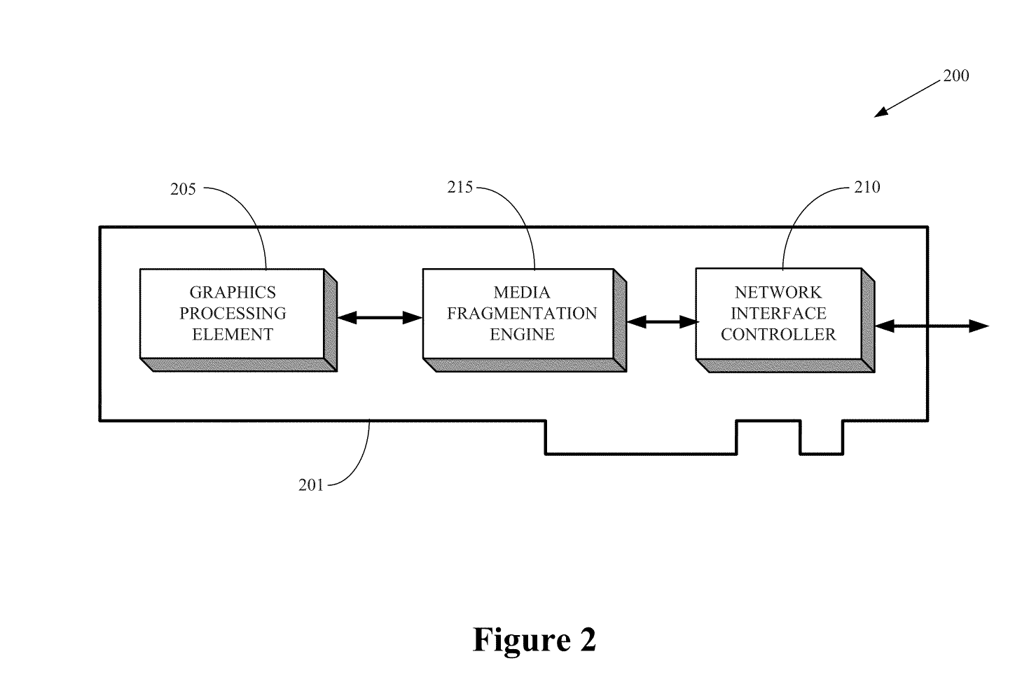

FIG. 2 conceptually illustrates a first exemplary embodiment of a semiconductor device 200 that may be formed in or on a semiconductor wafer (or die) 201. The semiconductor device 200 may be formed in or on the semiconductor wafer 201 using well known processes such as deposition, growth, photolithography, etching, planarising, polishing, annealing, and the like. In one embodiment, the semiconductor device 200 may be implemented in embodiments of the computer system 100 shown in FIG. 1. In the illustrated embodiment, the device 200 is a network-enabled graphics processing unit (NGPU) 200 that includes a graphics processing element 205 that is configured to access instructions or data for performing graphics operations such as rendering, pre-processing, or post-processing. However, as should be appreciated by those of ordinary skill the art, the graphics processing element 205 is intended to be illustrative and alternative embodiments may be configured to perform other operations related to media including audio, video, and the like. A network interface controller 210 is implemented in the network-enabled graphics processing unit 200 to facilitate communications over a network such as an Ethernet connection.

The illustrated embodiment of the network-enabled graphics processing unit 200 includes a media fragmentation engine 215 that is used to convert between the information formats used by the graphics processing element 205 and the network interface controller 210. For example, the graphics processing element 205 may generate graphics (or other media) information that can be provided to other internal or external devices, e.g., for display or presentation of the media information. This information may be presented in a format that is appropriate for representing the media such as audio, video, or other information. The media fragmentation engine 215 may divide, or fragment, the media information into portions that can be transmitted in payloads of one or more packets. The media fragmentation engine 215 may also form the appropriate headers and append these headers to the packet payloads. Packets formed by the media fragmentation engine 215 may then be provided to the network interface controller 210 for transmission over the network. In one embodiment, the media fragmentation engine 215 may also receive packets from the network interface controller 210 and process the received packets to generate media information from the packet payloads and provide the media information to the graphics processing element 205.

The illustrated embodiment of the NGPU 200 may be configured as an add-on element that may be coupled to other computer systems or hosts. For example, a physical plug may be used to link or couple the NGPU 200 to a bus in the external computer system. Embodiments of the NGPU 200 can be connected to many hosts via an Ethernet switch and in some embodiments each NGPU 200 may be configured to serve more than one host concurrently. The NGPU 200 may be connected or disconnected at any time including connecting or disconnecting the NGPU 200 while the host computer system is operating. For example, the host may interact with the NGPU 200 according to the Ethernet protocol so that the NGPU 200 can be plugged into or unplugged from the Ethernet network at any time. In one embodiment, the NGPU 200 may be switched on and off through “plug” or “unplug” operations. Alternatively, the NGPU 200 may be powered on or powered off using Power over Ethernet (POE) operations or commands. Multiple NGPUs 200 may be interconnected to form an NGPU 200 cluster. For example, a cluster may include thousands of interconnected NGPUs 200 that may be connected to a host such as a laptop and may initially be in a powered off state. The laptop user may be able to use the plug/unplug or power commands supported by the network to power up and initialize the cluster in a very short time, such as a few seconds.

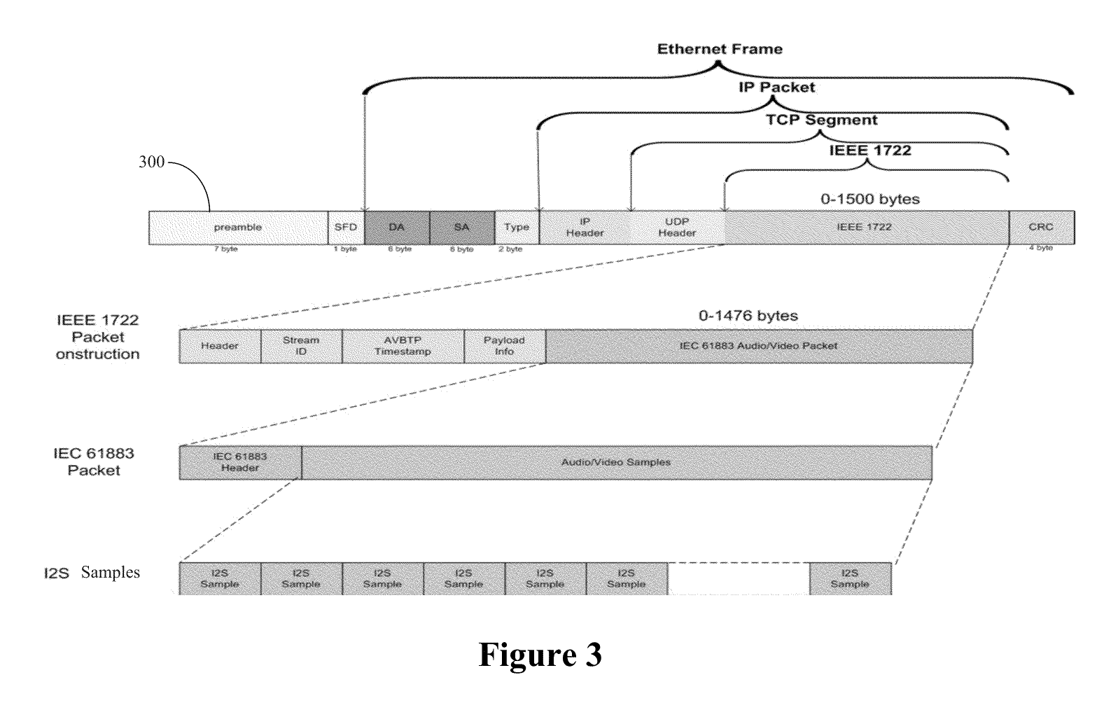

FIG. 3 conceptually illustrates one exemplary embodiment of a packet 300. In one embodiment, the packet 300 may be created by a media fragmentation engine (such as the media fragmentation engine 215 shown in FIG. 2) using information provided by a graphics processing element such as the graphics processing element 205 shown in FIG. 2. In another embodiment, which may be implemented in combination with the previous embodiment, the packet 300 may be received by the media fragmentation engine, which may extract media or graphics information and provide this information to the graphics processing element. The payload and headers of the packet 300 may be formed according to Ethernet protocols, Internet protocols (IP), transmission control protocols (TCP), link layer or layers 2 transfer protocols for time sensitive material (IEEE 1722), or other standards or protocols.

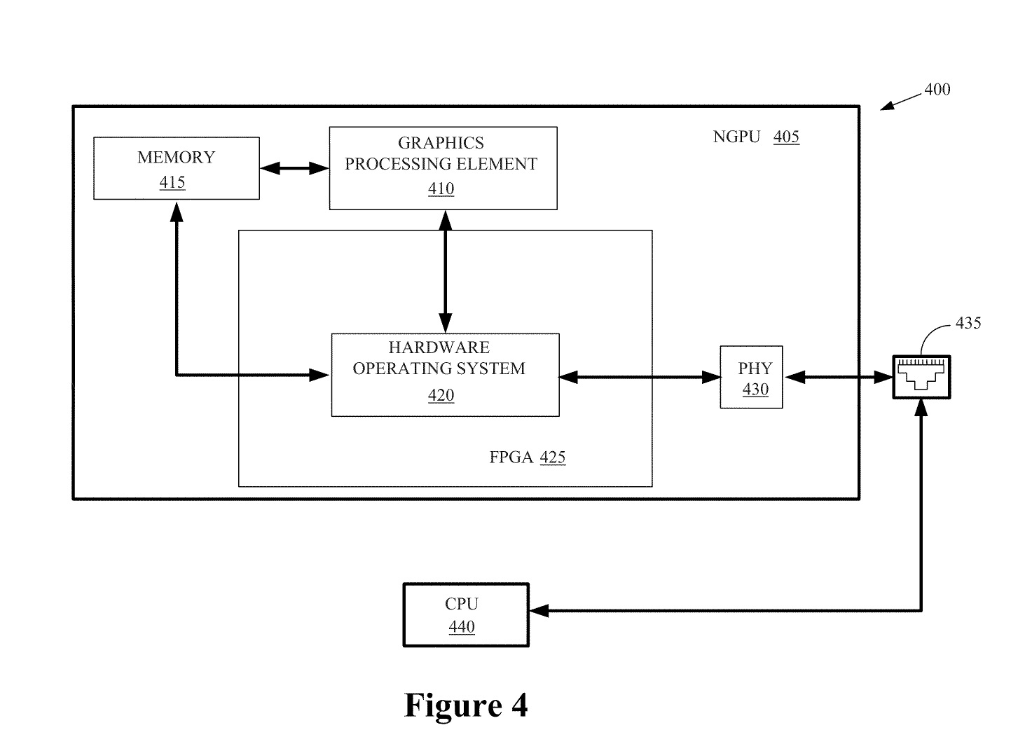

FIG. 4 conceptually illustrates a second exemplary embodiment of a processor-based system 400. In the second exemplary embodiment, the system 400 includes a network-enabled graphics processing unit (NGPU) 405. The illustrated embodiment of the NGPU 405 includes a graphics processing element 410 that can be used to perform graphics related operations. The graphics processing element 410 may be electromagnetically, communicatively, or physically connected to a memory 415 that may be used as a buffer or for storing instructions or data that are used by the graphics processing element 410. For example, the memory 415 may include buffers, registers, or caches such as L1 caches, L2 caches, and the like.

The NGPU 405 also includes a network interface controller that supports communication over a network such as an Ethernet. In the illustrated embodiment, the network interface controller is implemented using a hardware operating system 420. For example, the hardware operating system 420 may be implemented using a field programmable gate array (FPGA) 425. However, persons of ordinary skill in the art having benefit of the present disclosure should appreciate that the hardware operating system 420 may be implemented in other forms such as application-specific integrated circuits (ASICs). Alternatively, the operating system 420 may be implemented in hardware, firmware, software, or combinations thereof. In one embodiment, the operating system 420 may implement a media fragmentation engine for translating between packet formats and graphics formats, as discussed herein. Alternatively, the media fragmentation engine may be implemented as a stand-alone element or in other elements of the NGPU 405. The illustrated embodiment of the network interface controller also includes physical layer logic (PHY) 430 that may provide an electromagnetic, mechanical, or procedural interface to the transmission medium used to implement a network, e.g., the Ethernet. The physical layer logic 430 may be implemented in hardware, firmware, software, or combinations thereof.

A socket or connector 435 may also be used to connect the NGPU 405 to other internal or external devices. For example, the connector 435 may be an 8-position, 8-contact RJ45 modular connector 435 that may be used to terminate twisted pair cables or multi-conductor flat cables. In the illustrated embodiment, the connector 435 is used to connect the NGPU 405 to a central processing unit 440 so that these elements can exchange data or commands to coordinate operation. The NGPU 405 and the CPU 440 may be included in the same “box” or on the same substrate or, alternatively, they may be implemented in separate boxes or on separate substrates. For example, as discussed herein, the central processing unit 440 may be part of another computer system or host and the NGPU 405, perhaps in combination with other NGPUs, may be connected to the central processing unit 440 at any time.

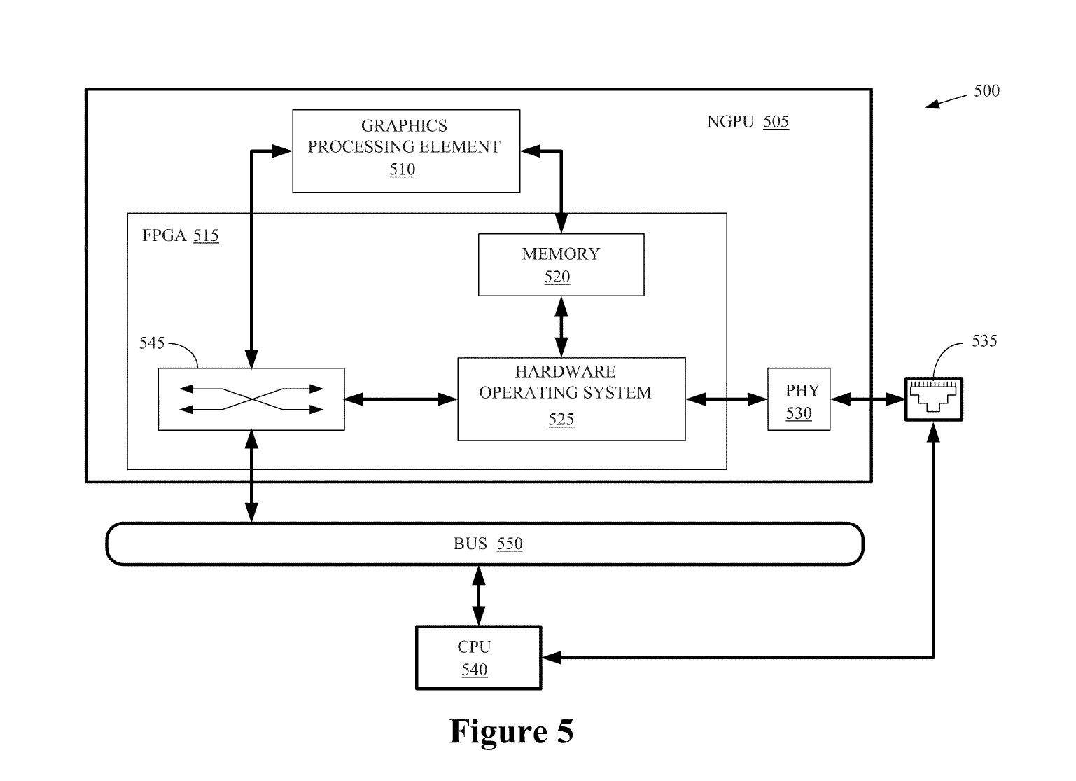

FIG. 5 conceptually illustrates a third exemplary embodiment of a processor-based system 500. In the third exemplary embodiment, the system 500 includes a network-enabled graphics processing unit (NGPU) 505. The illustrated embodiment of the NGPU 505 includes a graphics processing element 510 that can be used to perform graphics related operations. The graphics processing element 510 may be electromagnetically, communicatively, or physically connected to elements in an FPGA 515, e.g., using wires, traces, or buses such as PCI or PCIe buses. The illustrated embodiment of the FPGA 515 may be configured to include a memory 520 that may be used as a buffer or for storing instructions or data that are used by the graphics processing element 510. For example, the memory 520 may be configured to include buffers, registers, or caches such as L1 caches, L2 caches, and the like.

The illustrated embodiment of the FPGA 515 may also be configured to include a network interface controller that supports communication over a network such as an Ethernet. In the illustrated embodiment, the network interface controller is implemented using a hardware operating system 525 that may be “programmed” into the FPGA 515. However, persons of ordinary skill in the art having benefit of the present disclosure should appreciate that the hardware operating system 525 may be implemented in other forms such as application-specific integrated circuits (ASICs). Alternatively, the operating system 525 may be implemented in hardware, firmware, software, or combinations thereof. As discussed herein, a media fragmentation engine may be implemented in the operating system 525 or elsewhere in the NGPU 505. The illustrated embodiment of the network interface controller also includes physical layer logic (PHY) 530 that may provide an electromagnetic, mechanical, or procedural interface to the transmission medium used to implement a network, e.g., the Ethernet. The embodiment of the physical layer logic 530 shown in FIG. 5 is implemented outside of the FPGA 515. However, in alternative embodiments, the physical layer logic 530 may be implemented in any combination of hardware, firmware, or software including portions of the FPGA 515.

A connector 535 may be used to connect the NGPU 505 to other internal or external devices. For example, the connector 535 may be an 8-position, 8-contact RJ45 modular connector 535 that may be used to terminate twisted pair cables or multi-conductor flat cables. In the illustrated embodiment, the connector 535 is used to connect the NGPU 505 to a central processing unit 540. The NGPU 505 and the CPU 540 may be included in the same “box” or on the same substrate or, alternatively, they may be implemented in separate boxes or on separate substrates. The illustrated embodiment of the NGPU 505 also includes an interface 545 that may be implemented using the FPGA 515. Alternatively, the interface 545 may be implemented using other combinations of hardware, firmware, or software. The interface 545 may act as a router or bus interface between the graphics processing element 510, the hardware operating system 525, and a bus 550 such as a PCI bus or a PCIe bus. In the illustrated embodiment, the CPU 540 may also be electromagnetically, physically, or communicatively coupled to the bus 545.

The NGPU 505 may therefore communicate with the CPU 540 by exchanging signals using any combination of the network interface (e.g., as implemented in the hardware operating system 525, the physical layer logic 530, or the connector 535) and the interface 545 to the bus 540. For example, the NGPU 505 and the CPU 540 may use the high-bandwidth network interface for exchanging graphics processing data or other media data and the relatively lower bandwidth bus interface 545 for exchanging instructions or control information, which may be related to processing of the graphics or other media data. In various embodiments, different combinations of the network interface and the interface 545 may be used to exchange various types of information between the NGPU 505 and the CPU 540. The type or amount of information transmitted over the different interfaces may be predetermined or may be dynamically configured or selected based upon criteria such as the processing load on the NGPU 505 or the CPU 540, the type of information, the amount of information, the bandwidth of the different interfaces, and the like.

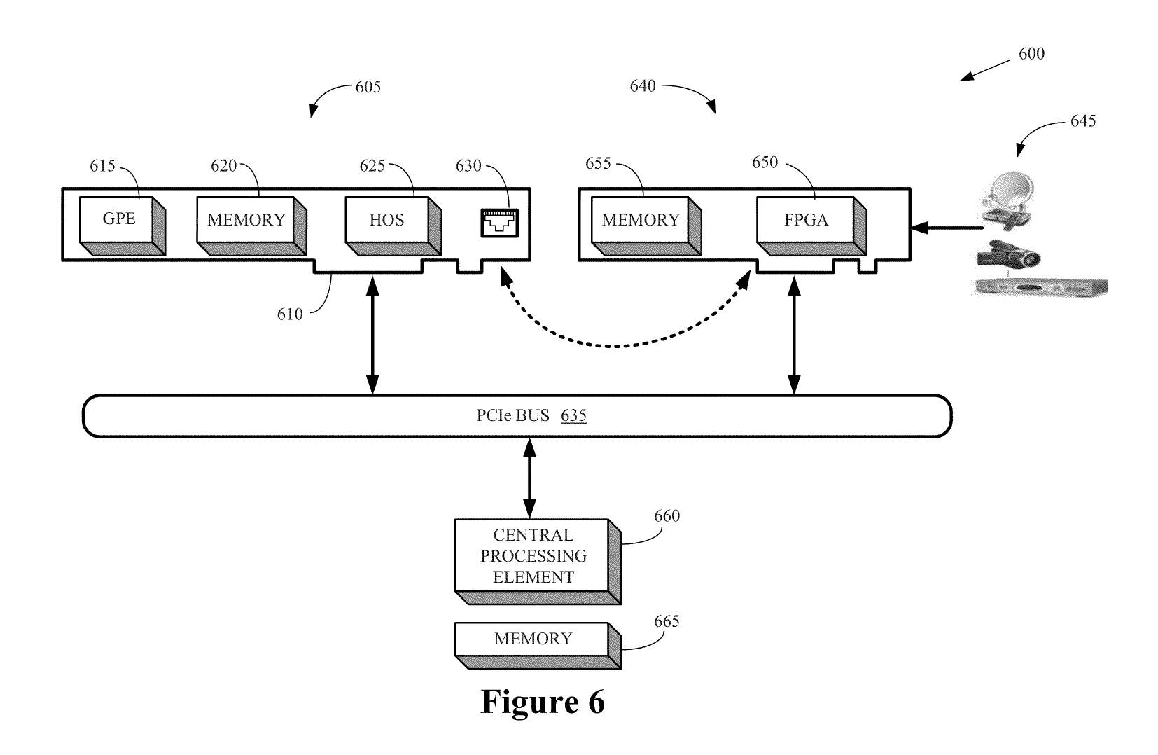

FIG. 6 conceptually illustrates a fourth exemplary embodiment of a processor-based system 600. In the illustrated embodiment, the processor-based system 600 includes a network-enabled graphics processing unit 605 that may be implemented on a card or substrate 610. The network-enabled graphics processing unit 605 includes a graphics processing element 615, a memory 620, a hardware operating system 625, and a network connector 630. In the illustrated embodiment, the hardware operating system 625 is configured to support a bus interface (not shown in FIG. 6) and a network interface (not shown in FIG. 6) such as an Ethernet interface, as discussed herein. The network-enabled graphics processing unit 605 may therefore be electromagnetically, physically, or communicatively connected to a bus 635 via the bus interface. In the illustrated embodiment, the bus 635 is a PCIe bus although alternative embodiments of the bus 630 may implement different types of buses.

The fourth exemplary embodiment of the processor-based system 600 also includes a media card 640 that is configured to capture and store information such as audio or video information provided by one or more external devices 645. In the illustrated embodiment, the media card 640 includes a FPGA 650 that may be configured to perform operations necessary for capturing or storing the information provided by the external devices 645. A memory 655 may also be incorporated in the media card 640 and used to buffer or store the media information or other information such as commands or instructions. The media card 640 also includes a bus interface (not shown in FIG. 6) and a network interface (not shown in FIG. 6) such as an Ethernet interface. In the illustrated embodiment, the media card 640 is electromagnetically, physically, or communicatively connected to the bus 635 via the bus interface. The media card 640 may also be electromagnetically, physically, or communicatively coupled to the network-enabled graphics processing unit 605 via the connector 630 or the bus 635.

A central processing element 660 and a memory 665 may also be electromagnetically, physically, or communicatively coupled to the bus 635. In the illustrated embodiment, the central processing element 660 implements one or more drivers in hardware, firmware, or software for the network-enabled graphics processing unit 605 and the media card 640. A central processing element 660 may therefore provide commands or instructions to the network-enabled graphics processing unit 605 or the media card 640 by transmitting signals via the bus 635. The central processing element 660 may also receive information from the network-enabled graphics processing unit 605 or the media card 640 via the bus 635. For example, the central processing unit 660, the media card 640, and the network-enabled graphics processing unit 605 may exchange instructions or data that are used to perform capture, storage, synchronization, rendering, preprocessing, or post-processing of the media information provided by the devices 645. In the illustrated embodiment, instructions may be conveyed via the bus 635 and media information may be conveyed using Ethernet connections.

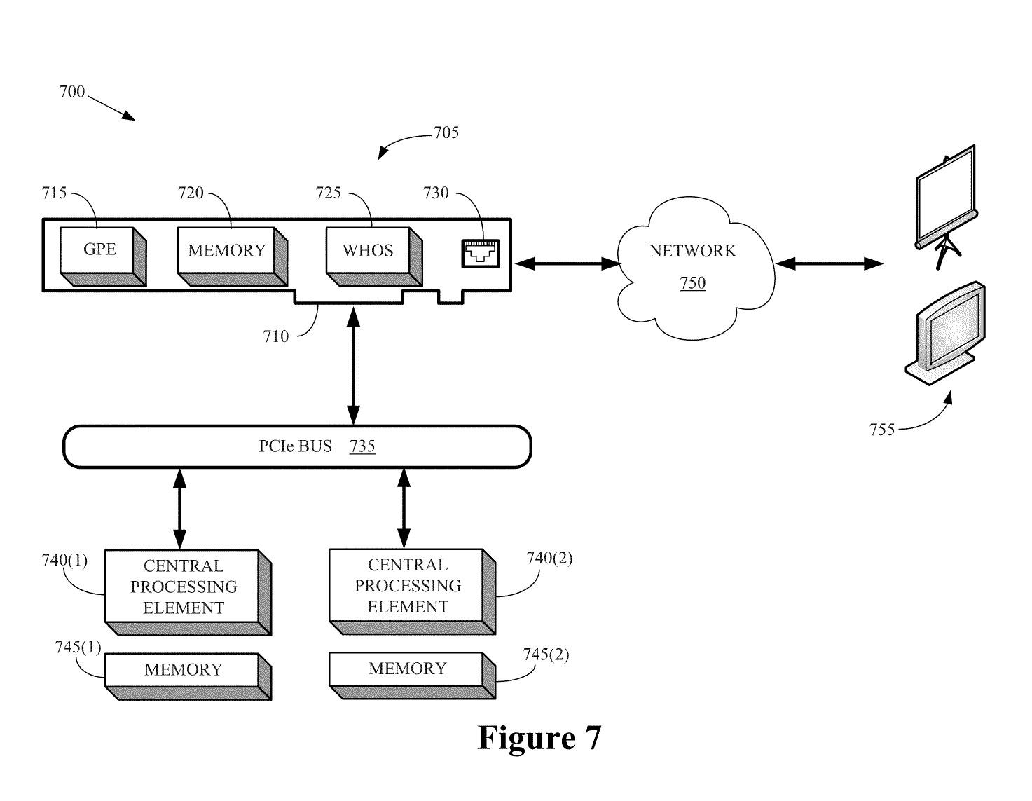

FIG. 7 conceptually illustrates a fifth exemplary embodiment of a processor-based system 700. In the illustrated embodiment, the processor-based system includes a network-enabled graphics processing unit 705 that may be implemented on a card or substrate 710. The network-enabled graphics processing unit 705 includes a graphics processing element 715, a memory 720, a hardware operating system 725, and a network connector 730. In the illustrated embodiment, the hardware operating system 725 is configured to support a bus interface (not shown in FIG. 7) and a network interface (not shown in FIG. 7) such as an Ethernet interface, as discussed herein. The network-enabled graphics processing unit 705 may therefore be electromagnetically, physically, or communicatively connected to a bus 735 via the bus interface. In the illustrated embodiment, the bus 735 is a PCIe bus although alternative embodiments of the bus 730 may implement different types of buses.

Central processing elements 740 and memory elements 745 may also be electromagnetically, physically, or communicatively coupled to the bus 735. Although two central processing elements 740 and memory elements 745 are shown in FIG. 7, persons of ordinary skill in the art having benefit of the present disclosure should appreciate that alternative embodiments may include more or fewer central processing elements 740 or memory element 745. In the illustrated embodiment, the central processing elements 740 may implement one or more drivers in hardware, firmware, or software for the network-enabled graphics processing unit 705. One or more of the central processing elements 740 may therefore provide commands or instructions to the network-enabled graphics processing unit 705 by transmitting signals via the bus 735. One or more central processing elements 740 may also receive information from the network-enabled graphics processing unit 705 via the bus 735. In one embodiment, the central processing elements 740 may work concurrently or in parallel to perform various tasks.

The network-enabled graphics processing unit 705 may be electromagnetically, physically, or communicatively coupled to an external network 750 such as an Internet, an intranet, or other type of network. The network-enabled graphics processing unit 705 may therefore communicate with external devices such as display elements 755. In the illustrated embodiment, the network-enabled graphics processing unit 705 may perform preprocessing, post-processing, or rendering of images or other media information, which may then be packetized and transmitted over the network 750 for eventual display by one or more of the display elements 755. Packets may also be received by the NGPU 705 over the network 750, e.g., from the display devices 755. In one embodiment, the network-enabled graphics processing unit 705 and the central processing elements 740 may be used to implement one or more virtual machines. For example, the different display elements 755 may be configured to run on different virtual machines supported by the central processing elements 740. Each display element 755 may therefore interact with a different virtual machine by exchanging signals over the network connection 730 and the bus 735.

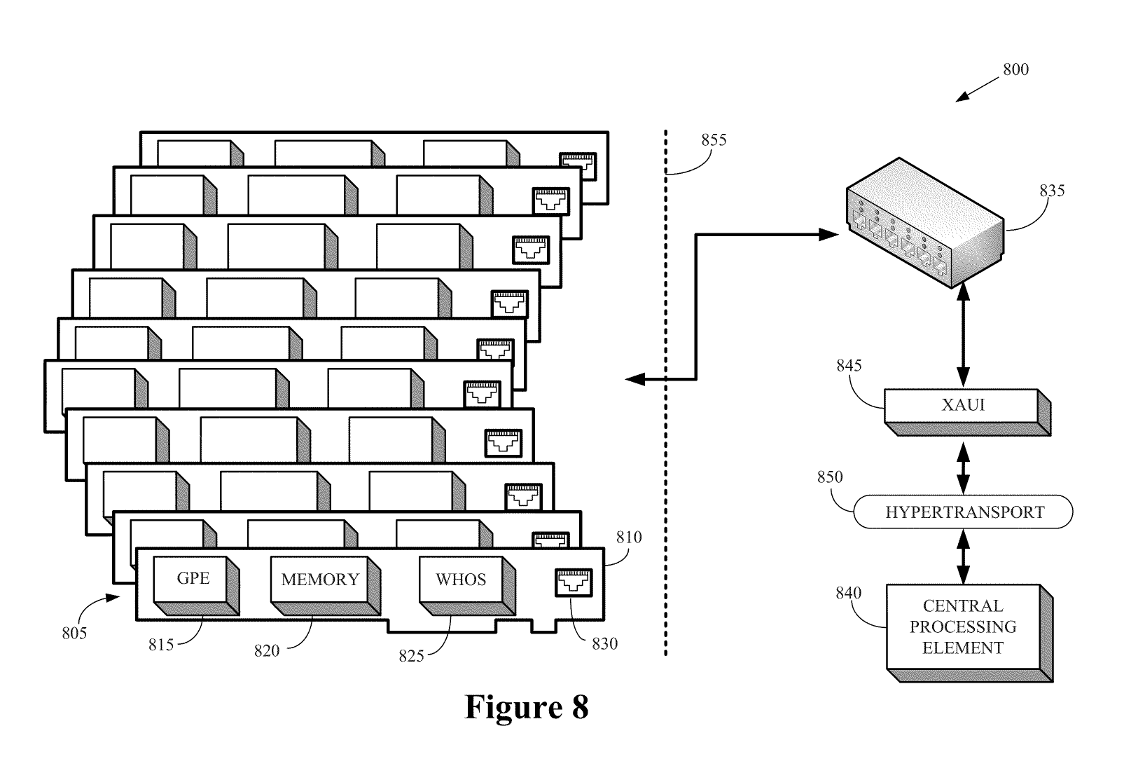

FIG. 8 conceptually illustrates a sixth exemplary embodiment of a processor-based system 800. In the illustrated embodiment, the processor-based system includes a plurality of network-enabled graphics processing units 805 that may be implemented on cards or substrates 810. Each network-enabled graphics processing unit 805 includes a graphics processing element 815, a memory 820, a hardware operating system 825, and a network connector 830. As discussed herein, the hardware operating systems 825 may be configured to support a bus interface or a network interface such as an Ethernet interface. In the illustrated embodiment, one or more of the network-enabled graphics processing units 805 may be configured to operate concurrently or in parallel.

In the illustrated embodiment, the network-enabled graphics processing units 805 are electromagnetically, physically, or communicatively coupled to a router 835 or other interconnecting device. The router 835 may then be electromagnetically, physically, or communicatively coupled to a central processing unit 840. In the illustrated embodiment, the router 835 connects to the central processing element 840 using a XAUI interface 845 and a HyperTransport interface 850. XAUI is a standard for extending the XGMII (10 Gigabit Media Independent Interface) between the MAC and PHY layer of 10 Gigabit Ethernet (10 GbE) which may be used by the router 835. HyperTransport is a bidirectional serial/parallel high-bandwidth, low-latency point-to-point link that may be used for interconnection of computer processors. Version 3.1 of HyperTransport may achieve a transfer rate as high as 25.6 GB/s (3.2 GHz×2 transfers per clock cycle×32 bits per link) per direction, or 51.2 GB/s aggregated throughput. Later versions of HyperTransport may achieve higher data transfer rates. However, persons of ordinary skill in the art having benefit of the present disclosure should appreciate that other interfaces may be used to connect the router 835 to the central processing element 840.

The network interfaces allow the network-enabled graphics processing units 805 to work in concert (e.g., concurrently or in parallel) to form a device with significantly higher processing power than a single GPU. For example, a conventional GPU communicates over a bus that may be limited to a bandwidth of 2 Gb per second or less. However, as discussed herein, the network bandwidth available to the network-enabled graphics processing units 805 can be many orders of magnitude larger. For example, the router 835 may support bandwidths of 10 GbE, 100 GbE, 1000 GbE, or even higher. In the illustrated embodiment, ten network-enabled graphics processing units 805 are combined into a single box, as indicated by the dashed line 855. The network-enabled graphics processing units 805 may then operate concurrently or in parallel to perform tasks such as rendering, preprocessing, post-processing, and the like. In the illustrated embodiment, the total processing power of the combined network-enabled graphics processing units 805 may be 40 Tflops or more.

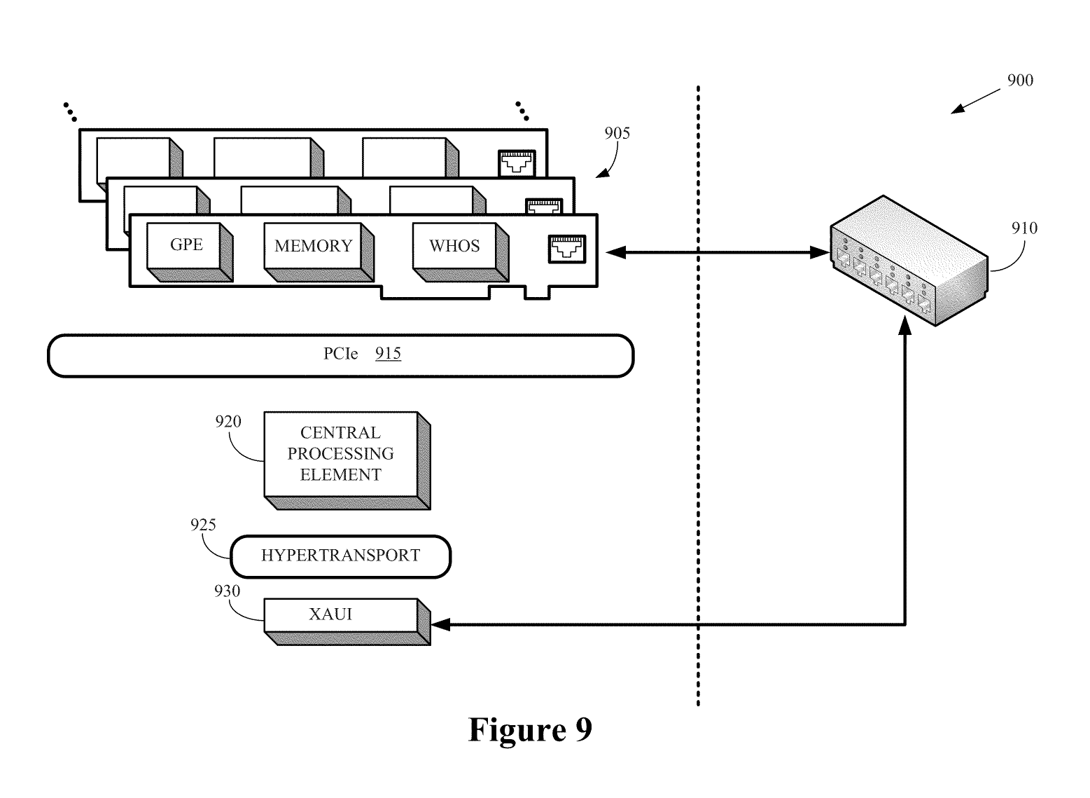

FIG. 9 conceptually illustrates a seventh exemplary embodiment of a processor-based system 900. In the illustrated embodiment, the processor-based system includes a plurality of network-enabled graphics processing units 905 that may be implemented in a single box, as discussed with regard to the sixth exemplary embodiment depicted in FIG. 8. The network-enabled graphics processing units 905 may be connected to a router 910 using a network interface supported by each network-enabled graphics processing unit 905. In the illustrated embodiment, the router 910 is implemented external to the box including the plurality of network-enabled graphics processing units 905. The network-enabled graphics processing units 905 may also include bus interfaces so that they may be electromagnetically, physically, or communicatively coupled to a bus 915. In one embodiment, the combined processing power of the network-enabled graphics processing units 905 may be 60 Tflops or more.

The seventh exemplary embodiment differs from the sixth exemplary embodiment by incorporating one or more central processing elements 920 into the box (or on the same substrate or card) that includes the network-enabled graphics processing units 905. The central processing element 920 may be electromagnetically, physically, or communicatively coupled to the bus 915 so that the network-enabled graphics processing units 905 and the central processing element 920 can communicate via the bus 915. In the illustrated embodiment, the router 910 connects to the central processing element 920 using a XAUI interface 925 and a HyperTransport interface 930. The central processing element 920 and the network-enabled graphics processing units 905 may therefore also communicate over the network using network interfaces and the router 910. In various alternative embodiments, data or instructions may be conveyed between the central processing element 920 and the network-enabled graphics processing units 905 using different combinations of the bus 915 or the router 910. For example, the central processing element 920 may implement drivers that convey instructions to the network-enabled graphics processing units 905 via the bus 915. Data may be conveyed between the central processing element 920 and the network-enabled graphics processing units 905 over the network via the router 910.

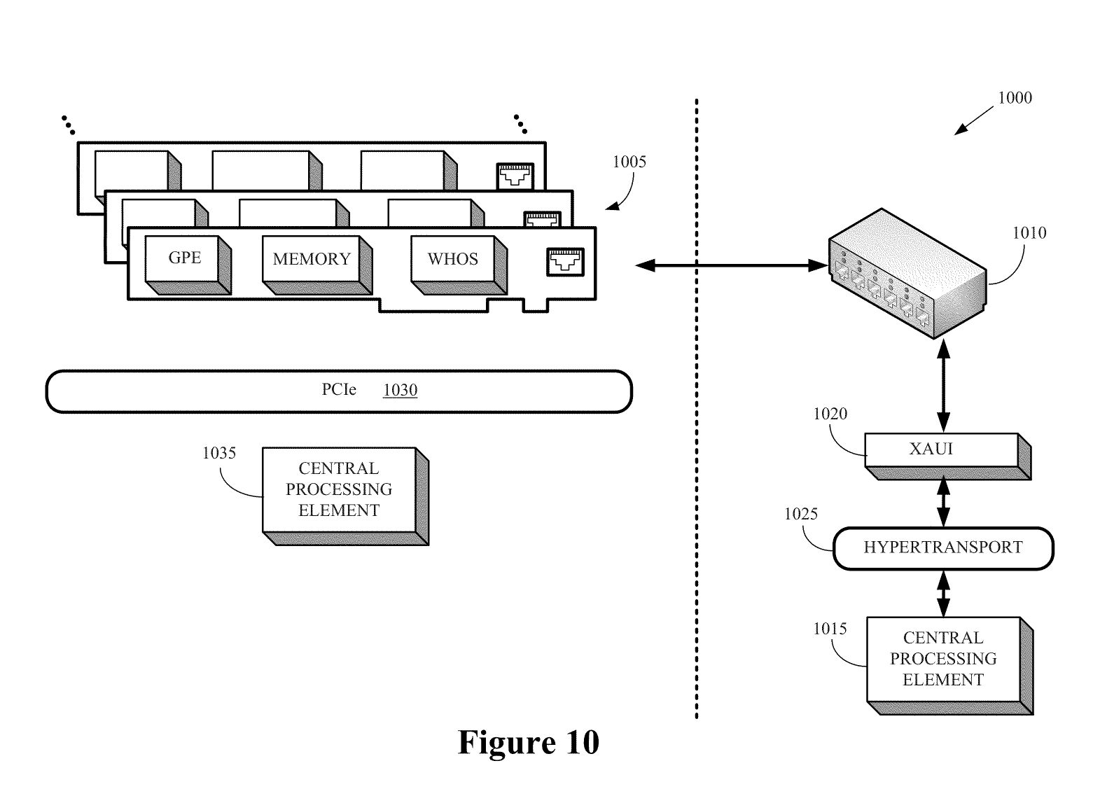

FIG. 10 conceptually illustrates an eighth exemplary embodiment of a processor-based system 1000. In the illustrated embodiment, the processor-based system 1000 includes a plurality of network-enabled graphics processing units 1005 that may be implemented in a single box, as discussed with regard to the sixth or seventh exemplary embodiments depicted in FIGS. 8-9. The network-enabled graphics processing units 1005 may be connected to a router 1010 using a network interface supported by each network-enabled graphics processing unit 1005. In the illustrated embodiment, the router 1010 is implemented external to the box including the plurality of network-enabled graphics processing units 1005. The router 1010 may then be electromagnetically, physically, or communicatively coupled to a central processing unit 1015 using a XAUI interface 1020 and a HyperTransport interface 1025. The network-enabled graphics processing units 1005 may also include bus interfaces so that they may be electromagnetically, physically, or communicatively coupled to a bus 1030. In one embodiment, the combined processing power of the network-enabled graphics processing units 1005 may be 40 Tflops or more.

The eighth exemplary embodiment differs from the sixth or seventh exemplary embodiments by incorporating one or more additional central processing elements 1035 into the box (or on the same substrate or card) that includes the network-enabled graphics processing units 1005. The central processing element 1035 may be electromagnetically, physically, or communicatively coupled to the bus 1030 so that the network-enabled graphics processing units 1005 and the central processing element 1035 can communicate via the bus 1030. In the illustrated embodiment, the central processing element 1035 implement drivers or other hardware, firmware, or software that can be used to control or coordinate operation of the network-enabled graphics processing units 1005.

In one embodiment, the central processing element 1035 may be configured to monitor or control operation of the network-enabled graphics processing units 1005 to match the number of operational or active network-enabled graphics processing units 1005 to the load on the system 1000 or the processing power required by a particular task or some other criteria. For example, when the system 1000 is performing a relatively large number of operations so that the load is high, the central processing element 1035 may instruct all of the network-enabled graphics processing units 1005 to operate concurrently or in parallel to perform the operations. When the system 1000 is performing a relatively small number of operations so that the load is low, the central processing element 1035 may instruct a subset of the network-enabled graphics processing units 1005 to shut down or enter an idle state to conserve power or other system resources. In one embodiment, the central processing element 1035 may be a relatively low performance device relative to the central processing element 1015.

Embodiments of processor systems that include network-enabled graphics processing units as described herein (such as the processor system 100) can be fabricated in semiconductor fabrication facilities according to various processor designs. In one embodiment, a processor design can be represented as code stored on a computer readable media. Exemplary codes that may be used to define or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarising, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. An integrated circuit, comprising:
a graphics processing element;
a media fragmentation engine; and
a network interface controller for conveying packets to or from the integrated circuit, and wherein the media fragmentation engine translates between a packet format used by the network interface and a graphics format used by the graphics processing element.

2. The integrated circuit of claim 1, wherein the network interface controller comprises an operating system implemented in hardware and a physical layer interface module.

3. The integrated circuit of claim 1, comprising at least one bus interface for conveying signals to or from the graphics processing element.

4. The integrated circuit of claim 3, wherein said at least one bus interface comprises at least one interface to at least one peripheral component interface (PCI) bus.

5. An apparatus, comprising:
at least one network-enabled graphics processing unit comprising:
a graphics processing element;
a media fragmentation engine; and
a network interface controller for conveying packets to or from the integrated circuit, and wherein the media fragmentation engine translates between a packet format used by the network interface and a graphics format used by the graphics processing element; and
at least one connector for communicatively coupling to the network interface controller.

6. The apparatus of claim 5, comprising at least one central processing unit that is communicatively coupled to said at least one network-enabled graphics processing unit using the network interface controller and said at least one connector, and wherein said at least one network-enabled graphics processing unit and said at least one central processing unit are configured to exchange data and control information using packets conveyed by the network interface controller.

7. The apparatus of claim 6, comprising at least one bus that is communicatively coupled to said at least one network-enabled graphics processing unit and said at least one central processing unit.

8. The apparatus of claim 7, wherein said at least one network-enabled graphics processing unit and said at least one central processing unit are configured to exchange control information over said at least one bus and to exchange data information using packets conveyed by the network interface controller.

9. The apparatus of claim 5, comprising a plurality of network-enabled graphics processing units.

10. The apparatus of claim 9, comprising at least one central processing unit that is communicatively coupled to the plurality of network-enabled graphics processing units using the network interface controllers and connectors in the plurality of network-enabled graphics processing units.

11. The apparatus of claim 10, wherein the plurality of network-enabled graphics processing units and said at least one central processing unit are configured to exchange data and control information using packets conveyed by the network interface controllers.

12. The apparatus of claim 10, comprising at least one bus that is communicatively coupled to the plurality of network-enabled graphics processing units and said at least one central processing unit.

13. The apparatus of claim 12, wherein the plurality of network-enabled graphics processing units and said at least one central processing unit are configured to exchange control information over said at least one bus and to exchange data information using packets conveyed by the network interface controllers.

14. The apparatus of claim 5, wherein said at least one network-enabled graphics processing unit is configured to receive graphics information captured by at least one external device using packets conveyed by the network interface controller.

15. The apparatus of claim 14, wherein said at least one graphics processing element is configured to perform at least one of preprocessing, postprocessing, or rendering using the received graphics information.

16. The apparatus of claim 5, wherein the graphics processing element is configured to perform at least one of preprocessing, postprocessing, or rendering of graphics information received from at least one central processing unit.

17. The apparatus of claim 16, wherein said at least one network-enabled graphics processing unit is configured to provide the graphics information to at least one external device using packets conveyed by the network interface controller.

18. The system of claim 5, comprising more than 10 network-enabled graphics processing units that are configurable to operate concurrently or in parallel.

19. The system of claim 5, comprising a plurality of central processing units that are configurable to operate concurrently or in parallel.

20. A computer readable media including instructions that when executed can configure a manufacturing process used to manufacture a semiconductor device comprising:
an integrated circuit comprising a graphics processing element, a media fragmentation engine, and a network interface controller for conveying packets to or from the integrated circuit, and wherein the media fragmentation engine translates between a packet format used by the network interface and a graphics format used by the graphics processing element.

21. The computer readable media set forth in claim 20, further comprising instructions that when executed can configure the manufacturing process used to manufacture the semiconductor device comprising at least one connector for communicatively coupling to the network interface controller.

22. The computer readable media set forth in claim 20, further comprising instructions that when executed can configure the manufacturing process used to manufacture the semiconductor device comprising at least one interface to at least one peripheral component interface (PCI) bus.
